(19) United States
(12) Patent Application Publication
(10) Pub. No.: US 2012/0209427 A1
(43) Pub. Date: Aug. 16, 2012

(54) MANIPULATOR WITH THREE DEGREES OF FREEDOM AND CONTROL METHOD FOR THE SAME

(75) Inventor: Chih-Hsien Kung, Tainan City (TW)

(73) Assignee: Chang Jung Christian University, Tainan (TW)

(21) Appl. No.: 13/237,458

(22) Filed: Sep. 20, 2011

(30) Foreign Application Priority Data
Feb. 16, 2011 (TW) 100105099

(51) Int. Cl. B25J 9/16; G06F 19/00

(52) U.S. Cl. 700/245; 901/2

(57) ABSTRACT

A manipulator with three degrees of freedom includes three actuators connected to a moving platform at angularly spaced apart positions that form vertices of a first regular triangle and connected to a base platform at angularly spaced apart positions that form vertices of a second regular triangle. A normal line through a centroid of the first regular triangle is aligned with a normal line through a centroid of the second regular triangle when the moving platform is at an initial position. A control method for the manipulator includes configuring the manipulator to compute respective lengths of the actuators based upon a desired roll angle, a desired pitch angle and a desired heave height, and to set the actuators to the respective lengths so that the moving platform moves to the desired roll angle, the desired pitch angle, and the desired heave height with respect to the base platform.

### CROSS-REFERENCE TO RELATED APPLICATION

This application claims priority of Taiwanese Application No. 100105099, filed on Feb. 16, 2011.

### BACKGROUND OF THE INVENTION

1. Field of the Invention

The present invention relates to a manipulator with three degrees of freedom and a control method for the same, more particularly to a manipulator with three degrees of freedom capable of rolling, pitching and heaving and to a control method for the same.

2. Description of the Related Art

FIG. 1 illustrates a conventional manipulator 1 with three degrees of freedom that is similar to the Stewart Platform. The convention manipulator 1 may be applied to a mechanical arm, a motion simulator (e.g. a flight simulator and a car-driving simulator), etc. The conventional manipulator 1 includes a base platform 14, a moving platform 15 disposed above and movable with respect to the base platform 14, and three variable-length actuators 11 to 13 connected between the base platform 14 and the moving platform 15. In particular, the variable-length actuators 11 to 13 are connected to the base platform 14 via respective pin joints 111, 121, 131, and are connected to the moving platform 15 via respective ball joints 112, 122, 132.

Kok-Meng Lee and Dharman K. Shah proposed a conventional control method for the conventional manipulator 1 in “Kinematic Analysis of a Three-Degrees-of-Freedom In-Parallel Actuated Manipulator,” IEEE Journal of Robotics and Automation, Vol. 4, No. 3, pages 354-360, June 1988. In this method, Z-Y-Z Euler angles are used for computing lengths of the variable-length actuators 11 to 13. However, since the computation of the lengths of the variable-length actuators 11 to 13 involving the Euler angles is extremely complicated, the conventional manipulator 1 requires an expensive high-speed computing kernel and is not suitable for a real-time and high precision simulator.

### SUMMARY OF THE INVENTION

Therefore, an object of the present invention is to provide a manipulator with three degrees of freedom and a control method for the same.

Accordingly, a manipulator with three degrees of freedom of the present invention comprises a base platform, a moving platform spaced apart from and movable with respect to the base platform, three variable-length actuators connected between the base platform and the moving platform, and a control unit.

The variable-length actuators are connected to the moving platform via respective ball joints at equally and angularly spaced apart positions that form vertices of a first regular triangle, and are connected to the base platform via respective pin joints at equally and angularly spaced apart positions that form vertices of a second regular triangle. A normal line of the moving platform through a centroid of the first regular triangle is aligned with a normal line of the base platform through a centroid of the second regular triangle when the moving platform is at an initial position relative to the base platform.

The control unit is configured to receive a set of a desired roll angle, a desired pitch angle and a desired heave height of the moving platform with respect to the base platform, and is operable to compute a length of each of the variable-length actuators based upon the desired roll angle, the desired pitch angle and the desired heave height, and to output a control signal to each of the variable-length actuators so as to set each of the variable-length actuators to the respective lengths thus computed. Hence, the moving platform moves to the desired roll angle, the desired pitch angle, and the desired heave height with respect to the base platform.

According to another aspect, a control method for the manipulator with three degrees of freedom according to the present invention comprises the following steps of:

a) configuring the control unit to receive a set of a desired roll angle, a desired pitch angle and a desired heave height of the moving platform with respect to the base platform;

b) configuring the control unit to compute a length of each of the variable-length actuators based upon the desired roll angle, the desired pitch angle, and the desired heave height; and

c) configuring the control unit to output a control signal to each of the variable-length actuators so as to set each of the variable-length actuators to the respective length computed in step b) so that the moving platform moves to the desired roll angle, the desired pitch angle, and the desired heave height with respect to the base platform.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a conventional manipulator with three degrees of freedom;

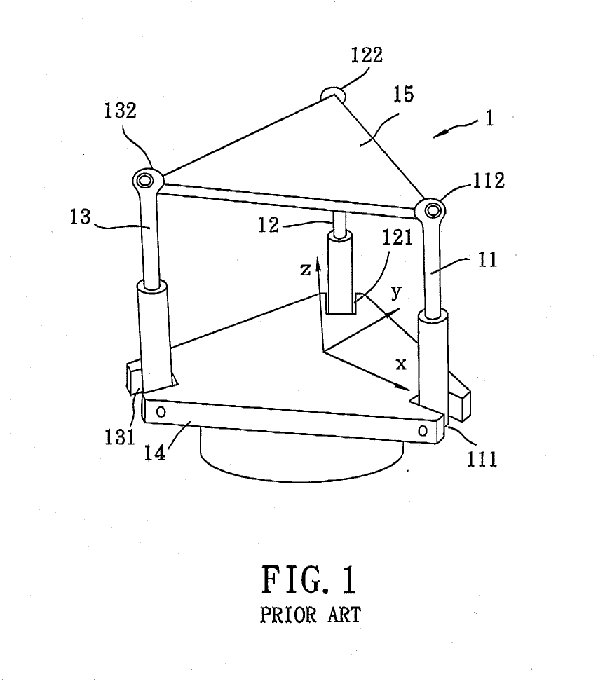

FIG. 2 is a schematic diagram of a preferred embodiment of a manipulator with three degrees of freedom according to the present invention; and

FIG. 3 is a flow chart of a control method for the manipulator of the preferred embodiment.

### DETAILED DESCRIPTION OF THE PREFERRED EMBODIMENT

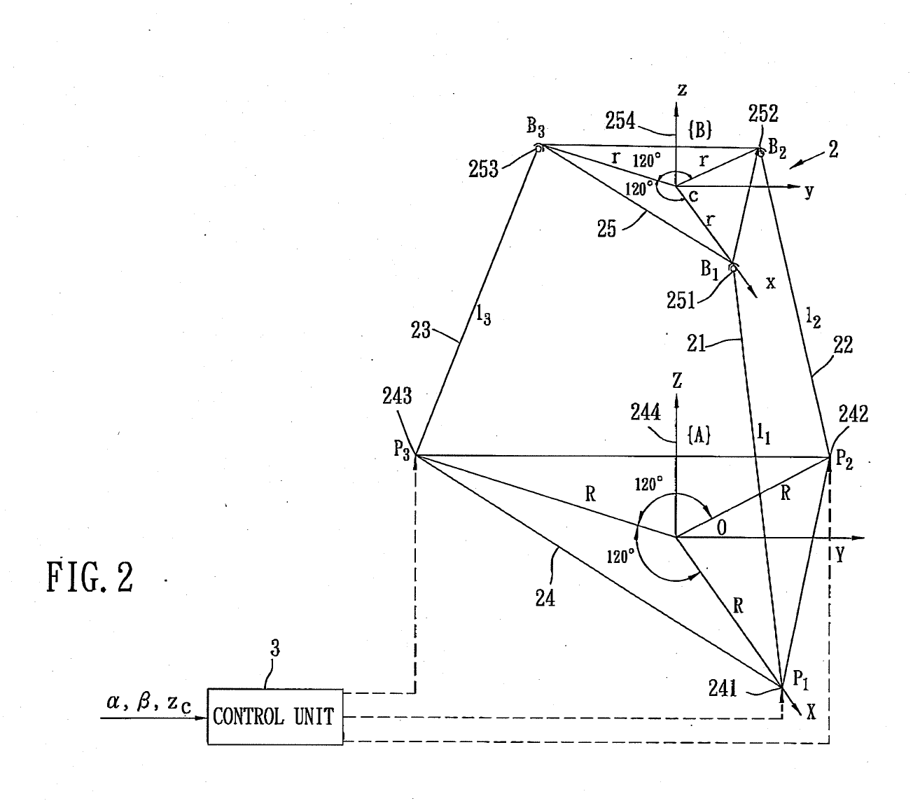

Referring to FIG. 2, a preferred embodiment of a manipulator 2 of this invention includes a base platform 24, a moving platform 25 spaced apart from the base platform 24, three variable-length actuators 21-23 connected between the base platform 24 and the moving platform 25, and a control unit 3. In this embodiment, the moving platform 25 is disposed above the base platform 24.

For example, the variable-length actuators 21, 22, 23 are fluid cylinders (such as hydraulic cylinders). The variable-length actuators 21, 22, 23 are connected to the moving platform 25 via respective ball joints 251, 252, 253 at equally and angularly spaced apart positions that form vertices (B₁, B₂, B₃) of a first (or upper) regular triangle (ΔB₁B₂B₃), that is to say, the ball joints 251, 252, 253 are angularly spaced apart from each other by 120° at an identical distance (r) from a centroid (c) of the upper regular triangle (ΔB₁B₂B₃). Similarly, the variable-length actuators 21, 22, 23 are connected to the base platform 24 via respective pin joints 241, 242, 243 at equally and angularly spaced apart positions that form vertices (P₁, P₂, P₃) of a second (or lower) regular triangle (ΔP₁P₂P₃). Namely, the pin joints 241, 242, 243 are angularly spaced apart from each other by 120° at an identical distance (R) from a centroid (O) of the lower regular triangle (ΔP₁P₂P₃).

In particular, a normal line 254 of the moving platform 25 through the centroid (c) of the upper regular triangle (ΔB₁B₂B₃) is aligned with a normal line 244 of the base platform 24 through the centroid (O) of the lower regular triangle (ΔP₁P₂P₃) when the moving platform 25 is at an initial position relative to the base platform 24. Namely, the normal line 254 of the moving platform 25 is a z-axis of a moving coordinate system {B} with the centroid (c) of the upper regular triangle (ΔB₁B₂B₃) as the origin thereof, and the normal line 244 of the base platform 24 is a Z-axis of a fixed coordinate system {A} with the centroid (O) of the lower regular triangle (ΔP₁P₂P₃) as the origin thereof.

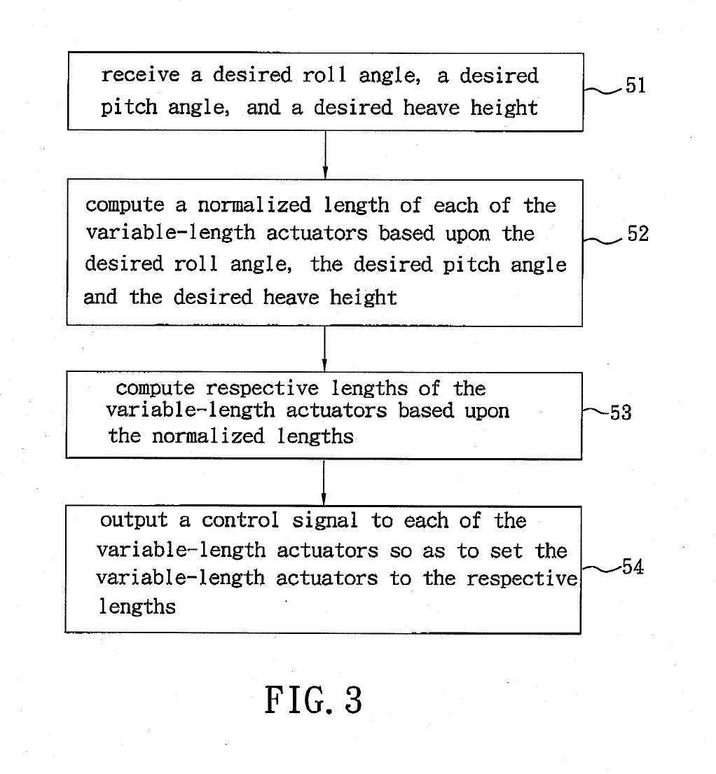

Referring to FIGS. 2 and 3, the control unit 3 is configured to implement a control method for the manipulator 2 of this embodiment. The control method includes the following steps.

In step 51, the control unit 3 is configured to receive a set of input parameters including a desired roll angle (α), a desired pitch angle (β) and a desired heave height (z_{c}) of the moving platform 25 with respect to the base platform 24.

In step 52, the control unit 3 is operable to compute a normalized length (L₁, L₂, L₃) of each of the variable-length actuators 21, 22, 23 based upon the desired roll angle (α), the desired pitch angle (β) and the desired heave height (z_{c}) received in step 51 using the following Equations (1) to (3).

L₁²=1+Z_{c}²+β²−2ρ(sin βZ_{c}+cos β) (1)

L₂²=1+Z_{c}²+β²−½ρ(cos β−\sqrt{3} sin α sin β+3 cos α)+ρ(sin β+\sqrt{3} sin α cos β)Z_{c} (2)

L₃²=1+Z_{c}²+ρ²−½ρ(cos β+\sqrt{3} sin α sin β+3cos α)+ρ(sin β−\sqrt{3} sin α cos β)Z_{c} (3)

In Equations (1), (2) and (3),

$${Z}_{c} = \frac{{z}_{c}}{R} , ρ = \frac{r}{R} ,$$

R is the distance between one of the pin joints 241-243 and the centroid (O) of the lower regular triangle (ΔP₁P₂P₃) and r is a distance between one of the ball joints 251-253 and the centroid (c) of the upper regular triangle (ΔB₁B₂B₃). The derivation of the Equations (1), (2) and (3) for computing the normalized lengths (L₁, L₂, L₃) of the variable-length actuators 21, 22, 23 will be described later.

Then, in step 53, the control unit 3 is operable to compute respective lengths (l₁, l₂, l₃) of the variable-length actuators 21, 22, 23 based upon l₁=L₁R, l₂=L₂R, and l₃=L₃R.

In step 54, the control unit 3 is operable to output a control signal to each of the variable-length actuators 21, 22, 23 so as to set the variable-length actuators 21, 22, 23 to the respective lengths (l₁, l₂, l₃) computed in step 53. Therefore, the moving platform 25 moves to the desired roll angle (α), the desired pitch angle (β), and the desired heave height (z_{c}) with respect to the base platform 24.

The following is provided for describing the derivation of the. Equations (1), (2) and (3) for computing the normalized lengths (L₁, L₂, L₃) of the variable-length actuators 21, 22, 23 with reference to “Kinematic Analysis of a Three-Degrees-of-Freedom In-Parallel Actuated Manipulator,” IEEE Journal of Robotics and Automation, Vol. 4, No. 3, pages 354-360, June 1988.

As shown in FIG. 2, the coordinates (\hat{P}₁, \hat{P}₂, \hat{P}₃) of each of the pin joints 241, 242, 243 in the fixed coordinate system {A} are expressed as

$${\hat{P}}_{1} = {[ \begin{matrix}R \\ 0 \\ 0\end{matrix} ]}_{XYZ} , {\hat{P}}_{2} = {[ \begin{matrix}- \frac{1}{2} R \\ \frac{\sqrt{3}}{2} R \\ 0\end{matrix} ]}_{XYZ} , and {\hat{P}}_{3} = {[ \begin{matrix}- \frac{1}{2} R \\ - \frac{\sqrt{3}}{2} R \\ 0\end{matrix} ]}_{XYZ} .$$

Similarly, the coordinates (\hat{b}₁, \hat{b}₂, \hat{b}₃) of each of the ball joints 251, 252, 253 in the moving coordinate system {B} are expressed as

$${\hat{b}}_{1} = {[ \begin{matrix}r \\ 0 \\ 0\end{matrix} ]}_{xyz} , {\hat{b}}_{2} = {[ \begin{matrix}- \frac{1}{2} r \\ \frac{\sqrt{3}}{2} r \\ 0\end{matrix} ]}_{xyz} , and {\hat{b}}_{3} = {[ \begin{matrix}- \frac{1}{2} r \\ - \frac{\sqrt{3}}{2} r \\ 0\end{matrix} ]}_{xyz} .$$

Further, the moving coordinate system {B} with respect to the fixed coordinate system {A} can be described by a homogeneous transformation matrix [T].

$$[ T ] = [ \begin{matrix}{n}_{1} & {o}_{1} & {a}_{1} & {x}_{c} \\ {n}_{2} & {o}_{2} & {a}_{2} & {y}_{c} \\ {n}_{3} & {o}_{3} & {a}_{3} & {z}_{c} \\ 0 & 0 & 0 & 1\end{matrix} ]$$

In the homogeneous transformation matrix [T], [x_{c} y_{c} z_{c}]^{T} corresponds to coordinates of the origin (i.e., the centroid (c)) of the moving coordinate system {B} with respect to the fixed coordinate system {A}, and \hat{n}=[n₁n₂ n₃]^{T}, ô=[o₁ o₂ o₃]^{T} and â=[a₁ a₂ a₃]^{T} correspond to directional unit vectors of the x-axis, y-axis and z-axis of the moving coordinate system {B} with respect to the fixed coordinate system {A}, respectively. Since the directional unit vectors (\hat{n}, ô, â) of the x-axis, y-axis and z-axis are orthonormal with each other, there are six constraint equations relative to the directional unit vectors (\hat{n}, ô, â).

\hat{n}·\hat{n}=1

ô·ô=1

â·â=1

ô·â=0

ô·\hat{n}=0

â·\hat{n}=0

The relationship between the coordinates (\hat{B}₁, \hat{B}₂, \hat{B}₃) of the position of each of the ball joints 251, 252, 253 with respect to the fixed coordinate system {A} and the coordinates (\hat{b}₁, \hat{b}₂, \hat{b}₃) of each of the ball joints 251, 252, 253 in the moving coordinate system {B} can be expressed as

$${[ \begin{matrix}{\hat{B}}_{1} \\ 1\end{matrix} ]}_{XYZ} = {[ T ] [ \begin{matrix}{\hat{b}}_{1} \\ 1\end{matrix} ]}_{xyz} , for i = 1 , 2 , 3. \qquad ( 4 )$$

Accordingly, the coordinates (\hat{B}₁, \hat{B}₂, \hat{B}₃) of the position of each of the ball joints 251, 252, 253 with respect to the fixed coordinate system {A} can be acquired as

$${\hat{B}}_{1} = [ \begin{matrix}{n}_{1} r + {x}_{c} \\ {n}_{2} r + {y}_{c} \\ {n}_{3} r + {z}_{c}\end{matrix} ] , {\hat{B}}_{2} = [ \begin{matrix}- \frac{1}{2} {n}_{1} r + \frac{\sqrt{3}}{2} {o}_{1} r + {x}_{c} \\ - \frac{1}{2} {n}_{2} r + \frac{\sqrt{3}}{2} {o}_{2} r + {y}_{c} \\ - \frac{1}{2} {n}_{3} r + \frac{\sqrt{3}}{2} {o}_{3} r + {z}_{c}\end{matrix} ] , \\ and {\hat{B}}_{3} = [ \begin{matrix}- \frac{1}{2} {n}_{1} r - \frac{\sqrt{3}}{2} {o}_{1} r + {x}_{c} \\ - \frac{1}{2} {n}_{2} r - \frac{\sqrt{3}}{2} {o}_{2} r + {y}_{c} \\ - \frac{1}{2} {n}_{3} r - \frac{\sqrt{3}}{2} {o}_{3} r + {z}_{c}\end{matrix} ] .$$

According to the coordinates (\hat{B}₁, \hat{B}₂, \hat{B}₃) of each of the ball joints 251, 252, 253 and the coordinates (\hat{P}₁, \hat{P}₂, \hat{P}₃) of each of the pin joints 241, 242, 243 with respect to the fixed coordinate system {A}, inverse kinematic equations of the variable-length actuators 21, 22, 23 can be expressed as Equations (5) to (7).

L₁²=(n₁ρ+X_{c}−1)²+(n₂ρ+Y_{c})²+(n₃ρ+Z_{c})² (5)

L₂²=¼[(−n₁ρ+\sqrt{3}o₁ρ+2X_{c}+1)²+(−n₂ρ+\sqrt{3}o₂ρ+2Y_{c}−\sqrt{3})²⁺⁽⁻n₂ρ+\sqrt{3}o₃ρ+2Z_{c})²] (6)

L₃²=¼[(−n₁ρ−\sqrt{3}o₁ρ+2X_{c}+1)²+(−n₂ρ−\sqrt{3}o₂ρ+2Y_{c}+\sqrt{3})² (7)

In Equations (5), (6) and (7),

$${X}_{c} = \frac{{x}_{c}}{R} , {Y}_{c} = \frac{{y}_{c}}{R} , and {Z}_{c} = \frac{{z}_{c}}{R} .$$

Since the variable-length actuators 21, 22, 23 are constrained by the pin joints 241, 242, 243 to move on planes of Y=0, Y=−\sqrt{3}X and Y=\sqrt{3}X, respectively, the constraint equations imposed by the pin joints 241, 242, 243 are

n₂ρ+Y_{c}=0, (8)

−n₂ρ+\sqrt{3}o₂ρ+2Y_{c}=−\sqrt{3}(−n₁ρ+\sqrt{3}o₁ρ+2X_{c}), and (9)

−n₂ρ−\sqrt{3}o₂ρ+2Y_{c}=\sqrt{3}(−n₁ρ−\sqrt{3}o₁ρ+2X_{c}). (10)

Further, the above constraint equations (8), (9) and (10) can be simplified as

$$\begin{matrix}{n}_{2} ρ - 2 {Y}_{c} = 3 {o}_{1} ρ , & ( 11 ) \\ {n}_{2} = {o}_{1} , and & ( 12 ) \\ {X}_{c} = \frac{ρ}{2} ( {n}_{1} - {o}_{2} ) . & ( 13 )\end{matrix}$$

Since Equation (12) imposes another orientation constraint in addition to the six constraint equations (i.e., \hat{n}·\hat{n}=ô·ô=â·â=1, and ô·â=ô·\hat{n}=â·\hat{n}=0), only two of the nine directional cosines ((n₁,n₂,n₃)^{T}, (o₁,o₂,o₃)^{T}, and (a₁,a₂,a₃)^{T}) of the directional unit vectors (\hat{n}, ô, â) are independent. Namely, the moving platform 25 has only two degrees of freedom in orientation. Moreover, Equations (8) and (13) relate X_{c} and Y^{c} to the directional cosines, that is to say, the moving platform 25 has only one degree of freedom in Cartesian position (i.e., along the Z-axis).

It should be noted that the inverse kinematic equations (5), (6), (7) define the lengths of the variable-length actuators 21, 22, 23 for prescribed position and orientation of the moving platform 25. In order to acquire the simplified Equations (1), (2) and (3) for computing the normalized lengths (L₁, L₂, L₃) of the variable-length actuators 21, 22 and 23, it is required to define the position and the orientation of the moving platform 25, that is to say, six variables must be defined. Since the manipulator 2 has three degrees of freedom, three of the six variables are independent, and the remaining dependent three of the six variables can be computed according to Equations (4), (8), (12) and (13).

It is assumed that the moving platform 25 rotates around the X-axis, the Y-axis and the z-axis in sequence with angles α, β and γ, respectively. The angles α and β define an approach vector of the moving platform 25, and the angle γ defines a spin angle around the approach vector.

Regarding the spin rotation, it is assumed that a reference vector ^{A}P with respect to the fixed coordinate system {A} has rolled with the angle α and pitched with the angle β. A spin rotation of a plane perpendicular to the z-axis in the moving coordinate system {B} with the angle γ with respect to the fixed coordinate system {A} can be deemed as a spin rotation of a plane perpendicular to the Z-axis in the fixed coordinate system {A} with an angle −γ with respect to the moving coordinate system {B}. Accordingly, the spin rotation of the reference vector ^{A}P around the z-axis with the angle −γ can be expressed as

^{B}P=_{A}^{B}Rₛₚᵢₙ(γ)·^{A}P=ROT(z,−γ)·^{A}P, (14)

where ^{B}P is the reference vector with respect to the moving coordinate system {B}, _{A}^{B}Rₛₚᵢₙ(γ) is a spin rotation matrix indicating the spin rotation of the moving coordinate system {B} with respect to the fixed coordinate system {A} with the angle γ, and ROT(z,−γ) is a rotation matrix expressing the rotation around the z-axis with the angle −γ.

Since _{A}^{B}R⁻¹=_{B}^{A}R and ROT⁻¹(\hat{k},−θ)=ROT(\hat{k},θ) for a rotation around a vector \hat{k} with an angle θ, the following Equation (15) can be derived.

_{B}^{A}Rₛₚᵢₙ(γ)=ROT⁻¹(z,−γ)=ROT(z,γ) (15)

Similarly, the following Equation (16) can be derived according to the same theory.

_{A}^{B}R_{roll-pitch}(α,β)=_{B}^{A}R_{roll-pitch}⁻¹(α,β)=[ROT(Y,β)·ROT(X,α)]⁻¹ (16)

In Equation (16), _{A}^{B}R_{roll-pitch}(α,β) is a roll-pitch rotation matrix indicating the relative roll and pitch rotation between the fixed coordinate system {A} and the moving coordinate system {B} with the angles a and β, respectively.

From Equations (14) to (16), a roll-pitch-spin rotation matrix _{B}^{A}R_{roll-pitch-spin}(α,β,γ) can be derived as

$$\begin{matrix}{}_{B}^{A}{R}{}_{roll - pitch - spot}^{} ( α , β , γ ) = [ ROT ( Y , β ) \cdot ROT ( X , α ) ] \cdot ROT ( z , γ ) \\ = [ \begin{matrix}cos β & 0 & sin β \\ 0 & 1 & 0 \\ - sin β & 0 & cos β\end{matrix} ] [ \begin{matrix}1 & 0 & 0 \\ 0 & cos α & - sin α \\ 0 & sin α & cos α\end{matrix} ] [ \begin{matrix}cos γ & - sin γ & 0 \\ sin γ & cos γ & 0 \\ 0 & 0 & 1\end{matrix} ] \\ = [ \begin{matrix}cos β cos γ + sin α sin β sin γ & - cos βsin γ + sin αsin β cos γ & cos α sin β \\ cos α sin γ & cos α cos γ & - sin α \\ - sin βcos γ + sin αcos β sin γ & sin βsin γ + sin αcos β cos γ & cos α cos β\end{matrix} ] \\ = [ \begin{matrix}{n}_{1} & {o}_{1} & {a}_{1} \\ {n}_{2} & {o}_{2} & {a}_{2} \\ {n}_{3} & {o}_{3} & {a}_{3}\end{matrix} ]\end{matrix}$$

Accordingly, components (n₁, n₂, n₃, o₁, o₂, o₃, a₁, a₂, a₃) of the directional unit vectors (\hat{n}, ô, â) of the moving platform 25 can be expressed by the roll angle α, the pitch angle β, and the spin angle γ.

n₁=cos β cos γ+sin α sin β sin γ

n₂=cos α sin γ

n₃=−sin β cos γ+sin α cos β sin γ

o₁=−cos β sin γ+sin α sin β cos γ

o₂=cos α cos γ

o₃=sin β sin γ+sin α cos β cosγ

a₁=cos α sin β

a₂=−sin α

a₃=cos α cos β

From Equation (12), n₂=o₁, the following equations will hold.

cos α sin γ=−cos β sin γ+sin α sin β cos γ

sin γ(cos α+cos β)=sin α sin β cos γ

Equation (13) can be modified as

$${X}_{c} = \frac{ρ}{2} ( cos βcosγ + sin αsinβsinγ - cos αcosγ ) .$$

Since the Z-axis of the fixed coordinate system {A} on the base platform 24 overlaps with the z-axis of the moving coordinate system {B} on the moving platform 25 when the moving platform 25 is at the initial position, i.e., the normal line 254 of the moving platform 25 is aligned with the normal line 244 of the base platform 24, it will hold that

$${X}_{c} = \frac{{x}_{c}}{R} = 0 and {Y}_{c} = \frac{{y}_{c}}{R} = 0.$$

In addition, due to the constraint on the structure of the manipulator 2 of this embodiment, the spin angle γ is equal to 0. Therefore, the components (n₁, n₂, n₃, o₁, o₂, o₃, a₁, a₂, a₃) of the directional unit vectors (\hat{n}, ô, â) of the moving platform 25 can be simplified as follow.

n₁=cos β

n₂=0

n₃=−sin β

o₁=sin α sin β

o₂−cos α

o₃=sin α cos β

a₁=cos αsin β

a₂=−sin α

a₃=cos α cos β

Then, the foregoing simplified components (n₁, n₂, n₃, o₁, o₂, o₃, a₁, a₂, a₃) of the directional unit vectors (\hat{n}, ô, â) of the moving platform 25 are substituted into the inverse kinematic equations of the variable-length actuators 21 to 23, Equations (5) to (7). As a result, the Equations (1), (2) and (3) for computing the normalized lengths (L₁, L₂, L₃) of the variable-length actuators 21, 22, 23 are acquired.

In summary, the control method for the manipulator 2 according to the present invention makes the computation of the respective lengths (l₁, l₂, l₃) of the variable-length actuators 21, 22, 23 relatively simple. As a result, movement of the moving platform 25 with respect to the base platform 24 is relatively fast and precise. Therefore, the manipulator 2 according to the present invention does not require an expensive high-speed computing kernel for the control unit 3.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A control method for a manipulator with three degrees of freedom, the manipulator including a base platform, a moving platform spaced apart from and movable with respect to the base platform, three variable-length actuators connected between the base platform and the moving platform, and a control unit, the variable-length actuators being connected to the moving platform via respective ball joints at equally and angularly spaced apart positions that form vertices of a first regular triangle, the variable-length actuators being connected to the base platform via respective pin joints at equally and angularly spaced apart positions that form vertices of a second regular triangle, a normal line of the moving platform through a centroid of the first regular triangle being aligned with a normal line of the base platform through a centroid of the second regular triangle when the moving platform is at an initial position relative to the base platform, said control method comprising the following steps of :
a) configuring the control unit to receive a set of a desired roll angle, a desired pitch angle and a desired heave height of the moving platform with respect to the base platform;
b) configuring the control unit to compute a length of each of the variable-length actuators based upon the desired roll angle, the desired pitch angle, and the desired heave height; and
c) configuring the control unit to output a control signal to each of the variable-length actuators so as to set each of the variable-length actuators to the respective length computed in step b) so that the moving platform moves to the desired roll angle, the desired pitch angle, and the desired heave height with respect to the base platform.

2. The control method as claimed in claim 1, wherein step b) includes the following sub-steps of:
configuring the control unit to compute a normalized length of each of the variable-length actuators based upon
L₁²=1+Z_{c}²+ρ²−2ρ(sin βZ_{c}+cos β),
L₂²=1+Z_{c}²+ρ²−½ρ(cos β−\sqrt{3} sin α sin β+3 cos α)+ρ(sin β+\sqrt{3} sin α cos β)Z_{c}, and
L₃²=1+Z_{c}²+ρ²−½ρ(cos β+\sqrt{3} sin α sin β+3 cos α)+ρ(sin β−\sqrt{3} sin α cos β)Z_{c},
where L₁ to L₃ are the respective normalized lengths of the variable-length actuators, α is the desired roll angle, β is the desired pitch angle,
$${Z}_{c} = \frac{{z}_{c}}{R}$$
and z_{c} is the desired heave height,
$$ρ = \frac{r}{R} ,$$
R is a distance between one of the pin joints and the centroid of the second regular triangle, and r is a distance between one of the ball joints and the centroid of the first regular triangle; and
configuring the control unit to compute the length of each of the variable-length actuators based upon
l₁=L₁R, l₂=L₂R, and l₃=L₃R,
where l₁ to l₃ are the respective lengths of the variable-length actuators.

3. A manipulator with three degrees of freedom, comprising:
a base platform;
a moving platform spaced apart from and movable with respect to said base platform;
three variable-length actuators connected between said base platform and said moving platform, said variable-length actuators being connected to said moving platform via respective ball joints at equally and angularly spaced apart positions that form vertices of a first regular triangle, said variable-length actuators being connected to said base platform via respective pin joints at equally and angularly spaced apart positions that form vertices of a second regular triangle;
wherein a normal line of said moving platform through a centroid of the first regular triangle is aligned with a normal line of said base platform through a centroid of the second regular triangle when said moving platform is at an initial position relative to said base platform; and
a control unit configured to receive a set of a desired roll angle, a desired pitch angle and a desired heave height of said moving platform with respect to said base platform, and operable to compute a length of each of said variable-length actuators based upon the desired roll angle, the desired pitch angle and the desired heave height, and to output a control signal to each of said variable-length actuators so as to set each of said variable-length actuators to the respective lengths thus computed so that said moving platform moves to the desired roll angle, the desired pitch angle, and the desired heave height with respect to said base platform.

4. The manipulator as claimed in claim 3, wherein said control unit is configured to:
compute a normalized length of each of said variable-length actuators based upon
L₁²=1+Z_{c}²+ρ²−2ρ(sin βZ_{c}+cos β),
L₂²=1+Z_{c}²+ρ²−½ρ(cos β−\sqrt{3} sin α sin β+3 cos α)+ρ(sin β+\sqrt{3} sin α cos β)Z_{c}, and
L₃²=1+Z_{c}²+ρ²−½ρ(cos β+\sqrt{3} sin α sin β+3 cos α)+ρ(sin β−\sqrt{3} sin α cos β)Z_{c},
where L₁ to L₃ are the respective normalized lengths of said variable-length actuators, α is the desired roll angle, β is the desired pitch angle,
$${Z}_{c} = \frac{{z}_{c}}{R}$$
and z_{c} is the desired heave height,
$$ρ = \frac{r}{R} ,$$
R is a distance between one of said pin joints and the centroid of the second regular triangle, and r is a distance between one of said ball joints and the centroid of the first regular triangle; and
compute the length of each of said variable-length actuators based upon
l₁=L₁R, l₂=L₂R, and l₃=L₃R,
where l₁ to l₃ are the respective lengths of said variable-length actuators.

5. The manipulator as claimed in claim 3, wherein said variable-length actuators are fluid cylinders.

6. The manipulator as claimed in claim 5, wherein said variable-length actuators are hydraulic cylinders.
